(19) United States
(12) Patent Application Publication
(10) Pub. No.: US 2010/0113990 A1
(43) Pub. Date: May 6, 2010

(54) PNEUMATIC DEVICE FOR CARDIOPULMONARY RESUSCITATION ASSIST

(76) Inventor: Ti-Li CHANG, Taichung Hsien (TW)

Correspondence Address: RABIN & Berdo, PC, 1101 14TH STREET, NW, SUITE 500, WASHINGTON, DC, 20005, US

(21) Appl. No.: 12/263,736

(22) Filed: Nov. 3, 2008

(51) Int. Cl. A61H 31/00

(52) U.S. Cl. 601/41; 601/43

(57) ABSTRACT

A pneumatic device for cardiopulmonary resuscitation assist includes a back plate and a compressing member. The back plate has two securing members mounted respectively on two sides of the back plate. The compressing member includes a mounting plate and a bladder. The mounting plate is detachably connected to the back plate and has an upper surface, a lower surface, a gas passage and two securing straps. The gas passage is formed on the upper surface of the mounting plate. The securing straps are respectively mounted on two sides of the mounting plate and respectively connected selectively to the securing members. The bladder is mounted on the lower surface of the mounting plate and communicates with the gas passage. The bladder can compress a patient's chest continuously and stably when repeatedly inflating the bladder, and this provides a good cardiac massage and prevents hurting the patient's ribs.

### BACKGROUND OF THE INVENTION

1. Field of Invention

The present invention relates to a pneumatic device, and more particularly to a pneumatic device for cardiopulmonary resuscitation assist and that is easy to carry and provides a better cardiopulmonary resuscitation effect than a manual cardiopulmonary resuscitation procedure does.

2. Description of the Related Art

Accidents like traffic accident and drowning or illnesses like heart attack and hypertension may cause shock and result in cardiac and respiratory arrests. When a patient suffers cardiac and respiratory arrests, the patient's brain cells, tissues and organs cannot acquire enough oxygen supply and lack of oxygen. In order to prevent lack of oxygen, a cardiopulmonary resuscitation (CPR) procedure must be performed continuously on the patient to maintain oxygenated blood flowing to the brain and the heart.

A conventional CPR procedure relies on manual cardiac massage and mouth-to-mouth insufflation performed by first-aid personnel to maintain the flow of oxygenated blood. However, because compressing depth and frequency of a manual cardiac massage may not be stable, the cardiopulmonary resuscitation effect on the patient is not good enough. Thus, some conventional first-aid devices are developed for cardiopulmonary resuscitation assist.

With reference to FIG. 16, a conventional first-aid device (80) performs a cardiac massage and an artificial respiration on a patient by repeatedly pushing an operating bar of the conventional first-aid device (80) to feed air. However, the conventional first-aid device (80) has a large volume and weight and is hard to carry. Additionally, the conventional first-aid device (80) still needs to be operated manually.

With reference to FIG. 17, a conventional belt (90) with detachable bladder (91) is used for cardiopulmonary resuscitation assist. The conventional belt (90) is wrapped around a patient and the bladder (91) abuts against the patient's chest. Then the bladder (91) is filled with air and expands to compress the patient's chest for a cardiac massage. Though the conventional belt (90) is light and easy to carry, there are some problems resulting from the conventional belt (90). Because the conventional belt (90) is wrapped around the patient, the conventional belt (90) applies circumferential pressure on the patient. Thus, the cardiac massage effect is not ideal and may hurt the patient's ribs if the applied pressure is too large. Moreover, air is filled into the bladder (91) by a compressor so that carrying and operating the full system is still not convenient.

To overcome the shortcomings, the present invention provides a pneumatic device for cardiopulmonary resuscitation assist to mitigate or obviate the aforementioned problems.

### SUMMARY OF THE INVENTION

The primary objective of the present invention is to provide a pneumatic device for cardiopulmonary resuscitation assist that is easy to carry and provides a better cardiopulmonary resuscitation effect than a manual cardiopulmonary resuscitation procedure does.

A pneumatic device for cardiopulmonary resuscitation assist in accordance with the present invention comprises a back plate and a compressing member. The back plate has two sides and two securing members mounted respectively on the sides of the back plate. The compressing member comprises a mounting plate and a bladder. The mounting plate is detachably connected to the back plate and has two sides, an upper surface, a lower surface, a gas passage and two securing straps. The gas passage is formed on the upper surface of the mounting plate. The securing straps are respectively mounted on the sides of the mounting plate and respectively connected selectively to the securing members of the back plate. The bladder is mounted on the lower surface of the mounting plate and communicates with the gas passage of the mounting plate.

When a patient's upper body is secured on the back plate with the compressing member, the bladder is repeatedly inflated through the gas passage to compresses the patient's chest continuously and stably. Because the compressing member is connected to the back plate rather than wrapping directly around the patient upper body, a pressure resulting from the inflation of the bladder is applied only on the patient's chest rather than other parts of the patient's upper body, and this provides a good cardiac massage and CPR assist effect and prevents hurting the patient's ribs. Additionally, the pneumatic device is small and easy to carry.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a pneumatic device for cardiopulmonary resuscitation assist in accordance with the present invention;

FIG. 2 is a top perspective view of a compressing member of the pneumatic device for cardiopulmonary resuscitation assist in FIG. 1;

FIG. 3 is a bottom perspective view of the compressing member of the pneumatic device for cardiopulmonary resuscitation assist in FIG. 1;

FIG. 4 is an exploded perspective view of the compressing member of the pneumatic device for cardiopulmonary resuscitation assist in FIG. 1;

FIG. 5 is an enlarged cross sectional side view of a female buckle of the pneumatic device for cardiopulmonary resuscitation assist in FIG. 1;

FIG. 6 is a top exploded perspective view of a second embodiment of a pneumatic device for cardiopulmonary resuscitation assist in accordance with the present invention;

FIG. 7 is a bottom exploded perspective view of the first embodiment of the pneumatic device for cardiopulmonary resuscitation assist in FIG. 6;

FIG. 8 is an enlarged cross sectional side view of the pneumatic device for cardiopulmonary resuscitation assist in FIG. 6;

FIG. 9 is an exploded perspective view of the compressing member of the pneumatic device for cardiopulmonary resuscitation assist in FIG. 2;

FIG. 10 is an enlarged side view in partial section of the pneumatic device for cardiopulmonary resuscitation assist in FIG. 6;

FIG. 11 is a top view of a control member of the pneumatic device for cardiopulmonary resuscitation assist in FIG. 6;

FIG. 12 is an operational perspective view of the pneumatic device for cardiopulmonary resuscitation assist in FIG. 6 with a female patient;

FIG. 13 is an enlarged side view of an auxiliary pad of the pneumatic device for cardiopulmonary resuscitation assist in FIG. 12 with the female patient;

FIG. 14 is an operational perspective view of the pneumatic device for cardiopulmonary resuscitation assist in FIG. 6 with a male patient;

FIG. 15 is an exploded perspective view of a third embodiment of the pneumatic device for cardiopulmonary resuscitation assist in accordance with the present invention;

FIG. 16 is an operational perspective view of a conventional manual pneumatic device for cardiopulmonary resuscitation assist in accordance with the prior art; and

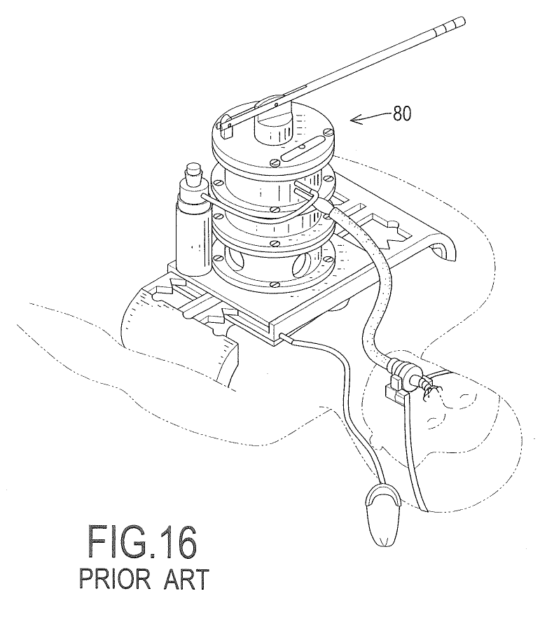

FIG. 17 is an operational perspective view of a conventional belt for cardiopulmonary resuscitation assist in accordance with the prior art.

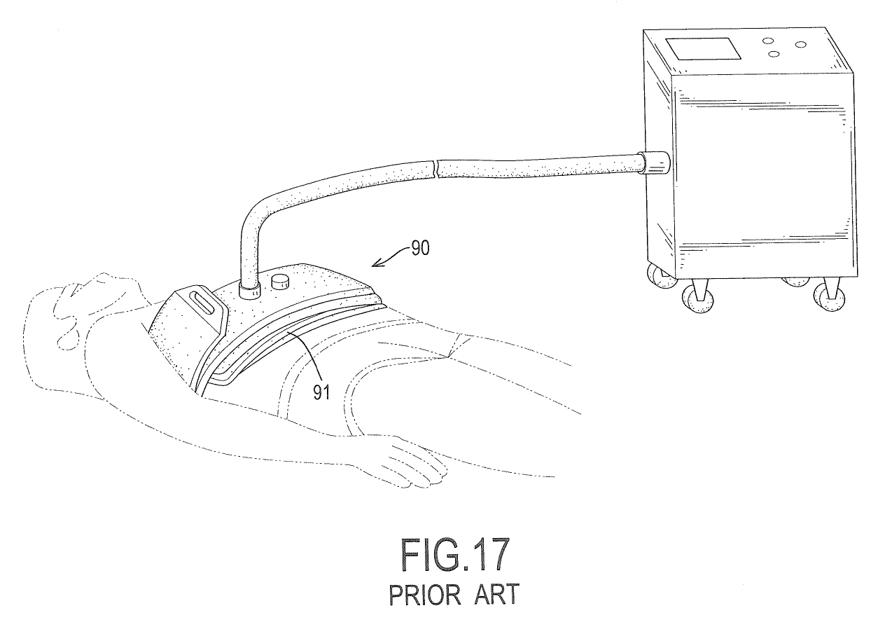

### DETAILED DESCRIPTION OF THE INVENTION

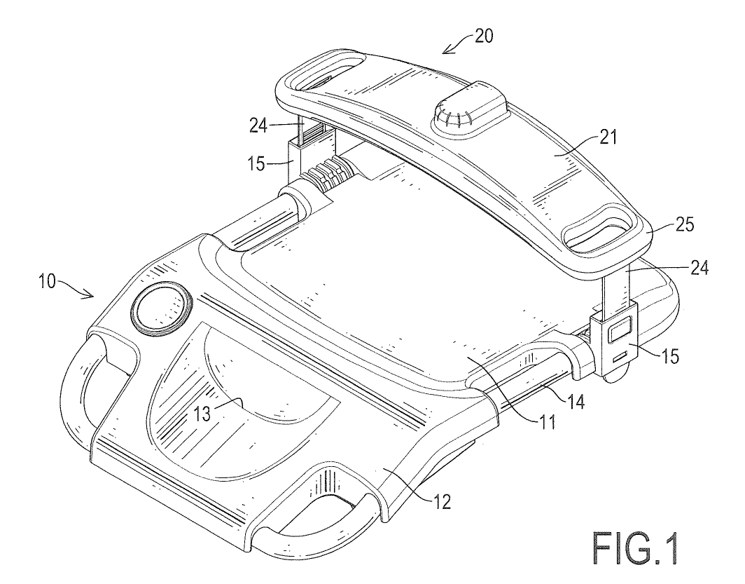

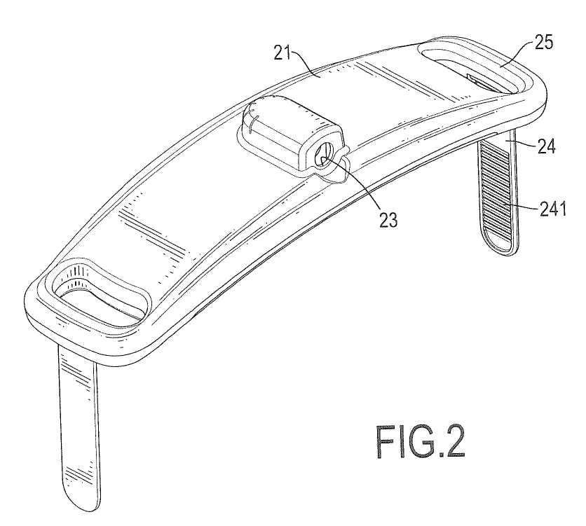

With reference to FIGS. 1, 2, 6 and 12, a pneumatic device for cardiopulmonary resuscitation assist in accordance with the present invention comprises a back plate (10), a compressing member (20) and may further comprise a control member (30), an oxygen bottle (40) and a mask (50).

The back plate (10) is substantially quadrangular and has two sides, a top surface, a receiving recess (13), two handles (14) and two securing members. The top surface is used for accommodating and securing a patient's upper body and has a body securing face (11) and a head placing face (12). The head placing face (12) is connected to and is inclined relative to the body securing face (11). The receiving recess (13) is defined in the head placing face (12) for holding the patient's head inside and can be formed at different positions to fit adults or children. When the patient's upper body is secured on the body securing face (11) and the patient's head is placed in the receiving recess (13), the patient's head is tilted and the patient's chin is lifted to facilitate airway management. The handles (14) are formed respectively on the sides of the back plate (10).

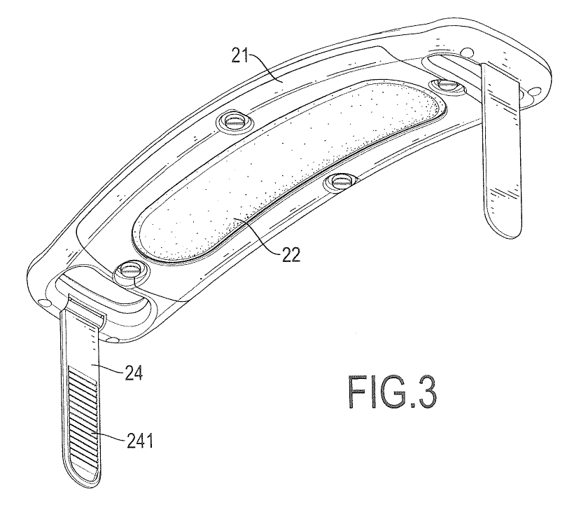

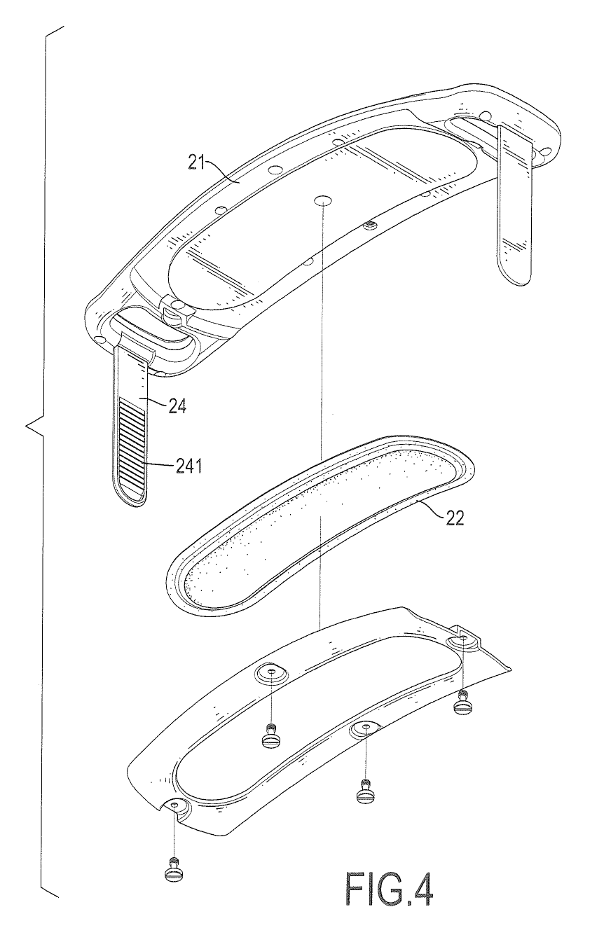

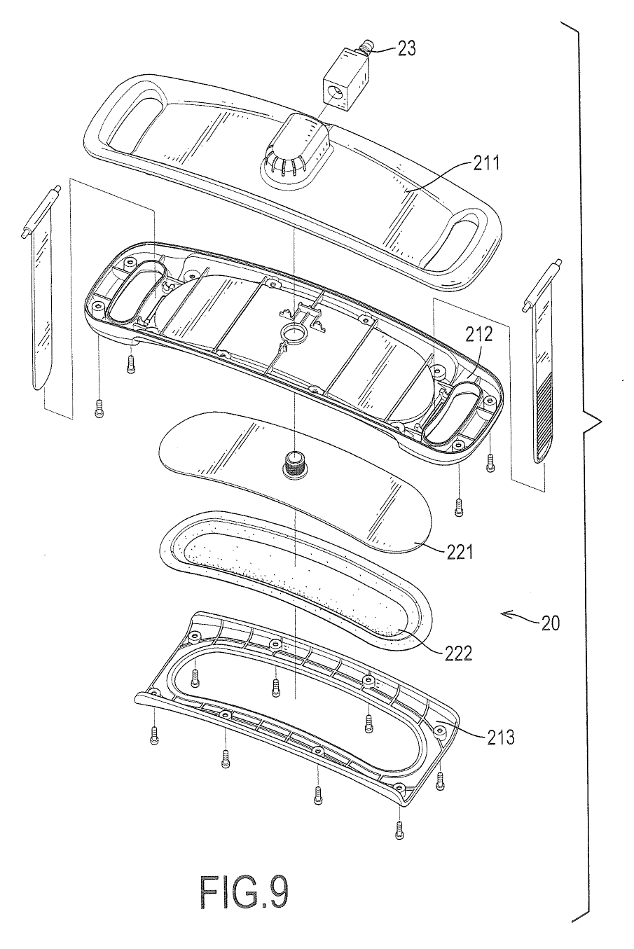

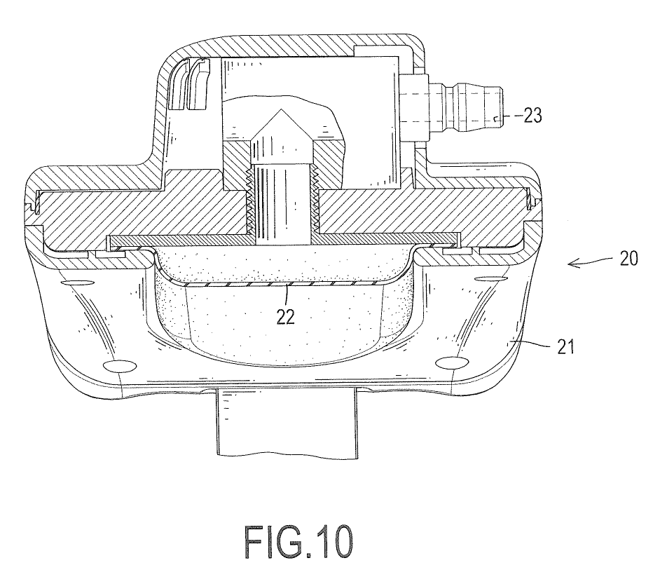

With further reference to FIGS. 3, 4, 9 and 10, the compressing member (20) is substantially quadrangular, is detachably connected to the back plate (10) and comprises a mounting plate (21) and a bladder (22). The mounting plate (21) has two sides, an upper surface, a lower surface, a gas passage (23), two securing straps (24) and two optional handles (25) and may comprise an upper plate (211), a middle frame (212) mounted on the upper plate (211) and a lower frame (213) mounted on the middle frame (212) and having an opening. The gas passage (23) is mounted on the upper surface of the mounting plate (21). The securing straps (24) are respectively mounted on the sides of the mounting plate (21) and respectively connected selectively to the securing members of the back plate (10), such that the patient's upper body can be secured on the back plate (10) with the securing straps (24).

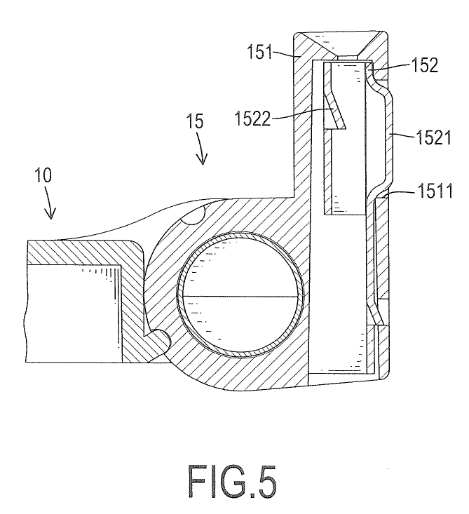

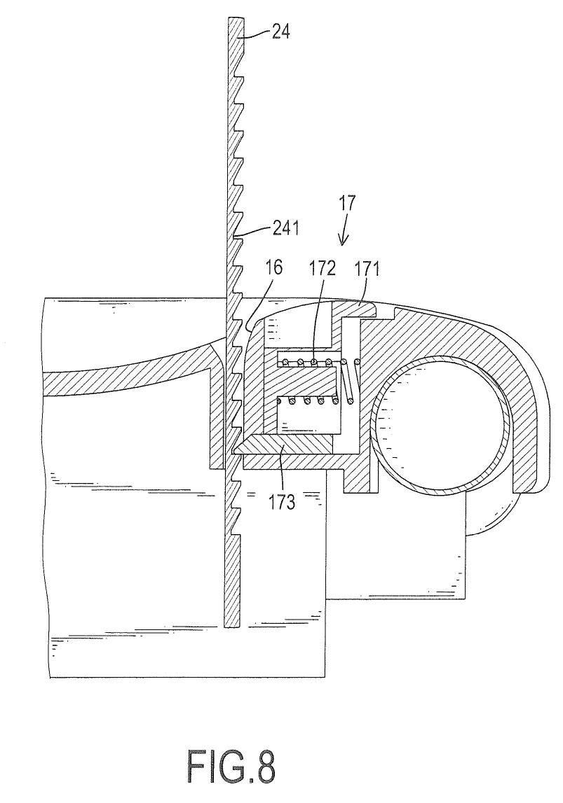

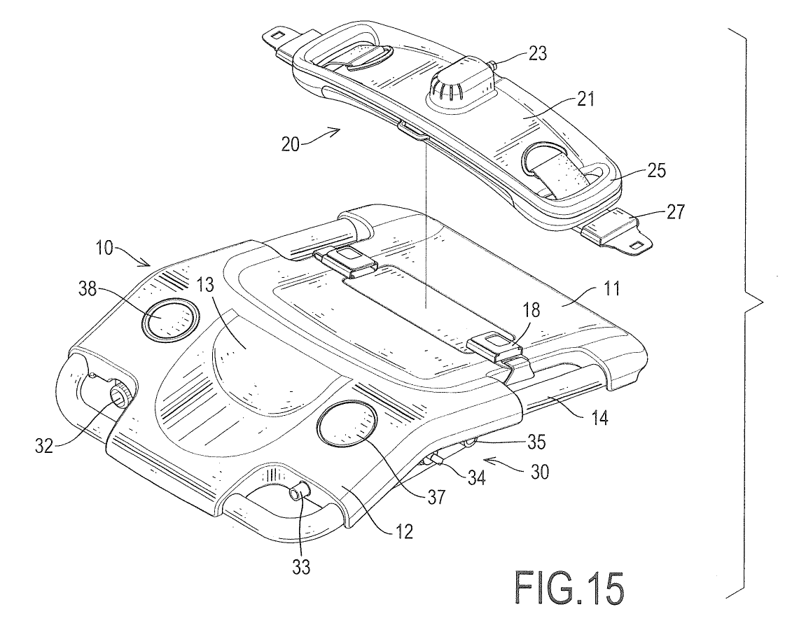

With reference to FIGS. 5, 8 and 15, the securing members are mounted respectively on the sides of the back plate (10) and each securing member (15) may be a female buckle (15,18) as shown in FIGS. 5 and 15 or may comprise a slot (16) and a securing button as shown in FIG. 8.

The female buckle (15,18) is attached/connected to one side of the back plate (10) and comprises a housing (151) and an engaging member (152). The housing (151) is attached/connected to the back plate (10), is hollow and has a top and a mouth and a window (1511). The mouth is defined through the top of the housing (151). The window (1511) is defined in the housing (151) through one side opposite to the back plate (10). The engaging member (152) is held in the housing (151) and comprises a pressed segment (1521) and an engaging tab (1522). The pressed segment (1521) is formed on one side of the engaging member (152) and is held in the window (1511) in the housing (151). The engaging tab (1522) is formed on the other side of the engaging member (152) and extends toward the pressed segment (1521).

The slot (16) is defined through one of the sides of the back plate (10). The securing button is mounted beside the slot (16) and comprises a slide block (151), a spring (172) and a tongue (173). The slide block (171) is mounted slidably in the back plate (10). The spring (172) is mounted between the slide block (171) and the back plate (10) to provide a resilient force to the slide block (171). The tongue (173) is mounted on the slide block (171) and extends selectively into the slot (16).

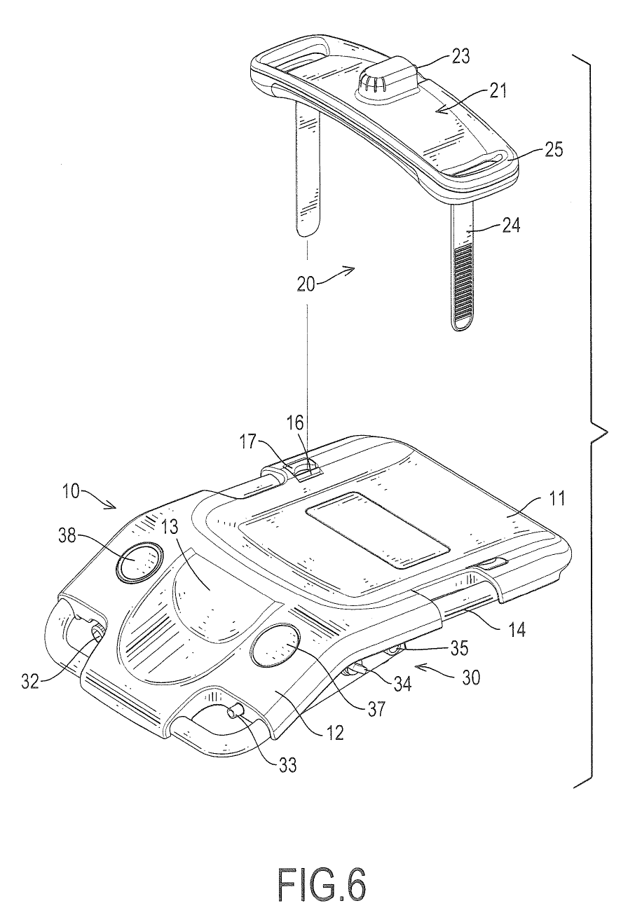

Each securing strap (24) may have a male buckle (27) as shown in FIG. 15 or a teeth portion as shown in FIGS. 1 and 6. The male buckle (27) corresponds, is connected selectively to one of the female buckles (15,18) and engages the engaging member (152) in the female buckles (15,18). The teeth portion is inserted selectively into one of the female buckles (15) via the mouths or slots (16), corresponds to one of the engaging members (152) or securing buttons and has multiple teeth (241). One of the teeth (241) selectively engages the engaging tab (1522) of the corresponding engaging member (152) or the tongue (173) of the corresponding securing button to fasten the strap (24) and prevent the compressing member (20) from detaching from the back plate (10).

When the pressed segment (1521) of the engaging member (152) is pressed through the window (1511), the engaging member (152) will be moved relative to the housing (151) to disengage the engaging tab (1522) from the corresponding male buckle (27) or teeth portion of the corresponding strap (24). Consequently, the male buckles (27) or straps (24) can be separated from the female buckles (15).

When the securing buttons are slid to bring the tongues (173) away respectively from the teeth portions of the straps (24), the straps (24) can be separated from the slots (16) of the back plate (10) and the compressing member (20) can be detached from the back plate (10) to release the patient's upper body.

The handles (25) are formed respectively on the sides of the mounting plate (21).

The bladder (22) is mounted on the lower surface of the mounting plate (21) to abut the patient's chest, communicates with the gas passage (23) of the mounting plate (21) and may comprise a lining plate (221) and a resilient bladder sheet (222). The lining plate (221) is attached to the middle frame (212) of the mounting plate (21) and has a through hole communicating with the gas passage (23) on the mounting plate (21). The bladder sheet (222) is attached securely to the lining plate (221) by ultrasonic or high frequency combining process to prevent gas from leaking out of the bladder (22) and form a space for holding gas and protrudes selectively from the opening of the lower frame (213). When the bladder (22) is inflated repeatedly with gas through the gas passage (23), the bladder (22) extends outwards and repeatedly compresses the patient's chest to provide a cardiac massage effect.

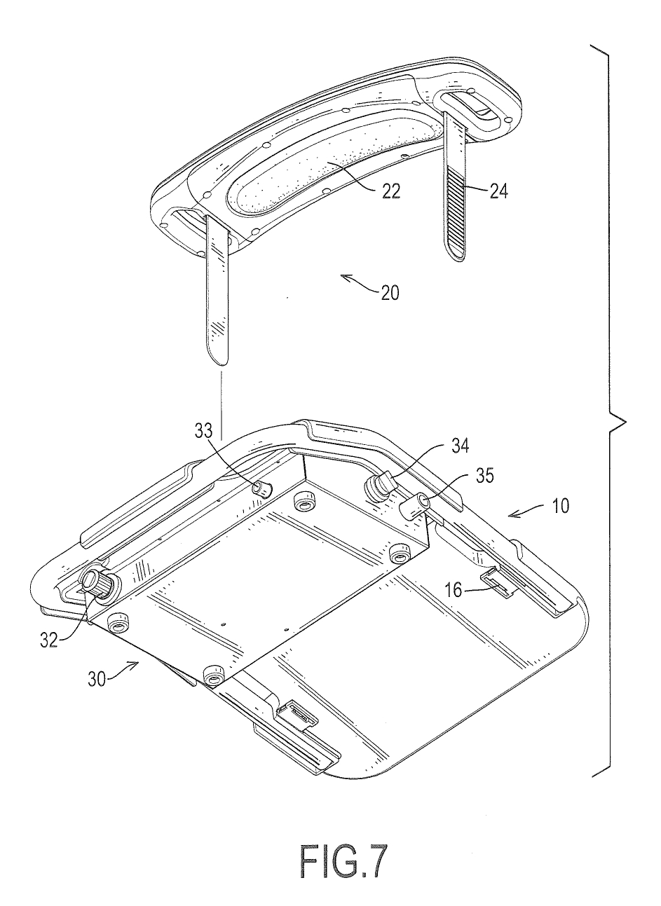

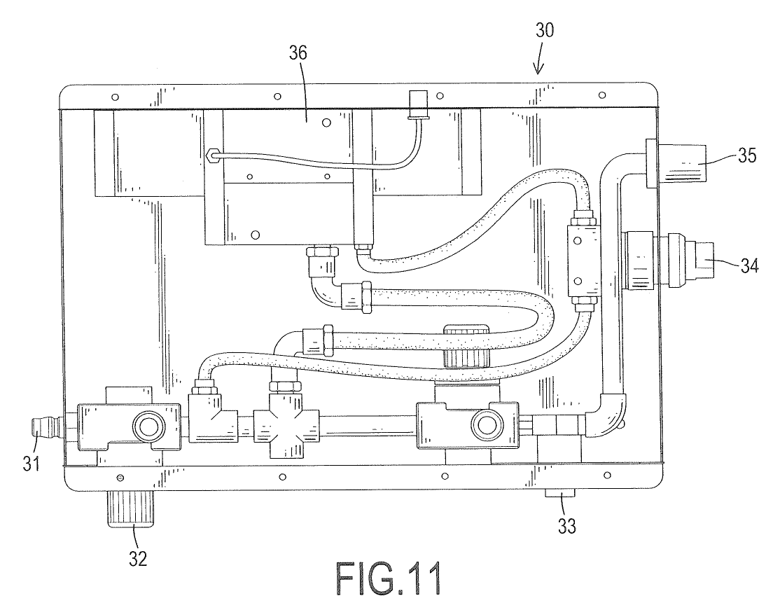

With reference to FIGS. 6, 7, 11 and 12, the control member (30) comprises a gas inlet (31), a gas outlet (35), a pressure controller (32), a flow controller (33), an inflation controller (36), a switch (34), a moisture gauge (37) and a pressure gauge (38). The gas inlet (31) may be connected to a gas supply. The gas outlet (35) is connected to the gas inlet (31) through a gas pipe. The pressure controller (32) is connected to the gas pipe to control gas pressure in the gas pipe. The flow controller (33) is connected to the gas pipe to control gas flow rate in the gas pipe. The inflation controller (36) is connected to the gas pipe and communicates with the gas passage (23) of the mounting plate (21) through an inflation pipe to control a periodical inflation of the bladder (22). The switch (34) is connected to the inflation controller (36) to turn on and off the inflation of the bladder (22). The moisture gauge (37) is connected to the gas pipe and is mounted on the head placing face (12) to indicate a moisture in the gas pipe. The pressure gauge (38) is connected to the gas pipe and is mounted on the head placing face (12) to indicate a pressure in the gas pipe.

The oxygen bottle (40) is connected to the gas inlet (31) of the control member (30) to supply the gas pipe with oxygen. Then oxygen flows through the inflation controller (36), the inflation pipe and gas passage (23) and into the bladder (22).

The mask (50) is connected to the gas outlet (35) of the control member (30) and is used to cover a patient's mouth and nose to perform an artificial respiration with oxygen supply. Therefore, the pneumatic device is driven by the oxygen bottle (40) to perform the cardiac massage and the artificial respiration at the same time. Accordingly, carrying and operating the pneumatic device are easy and convenient with the oxygen bottle (40).

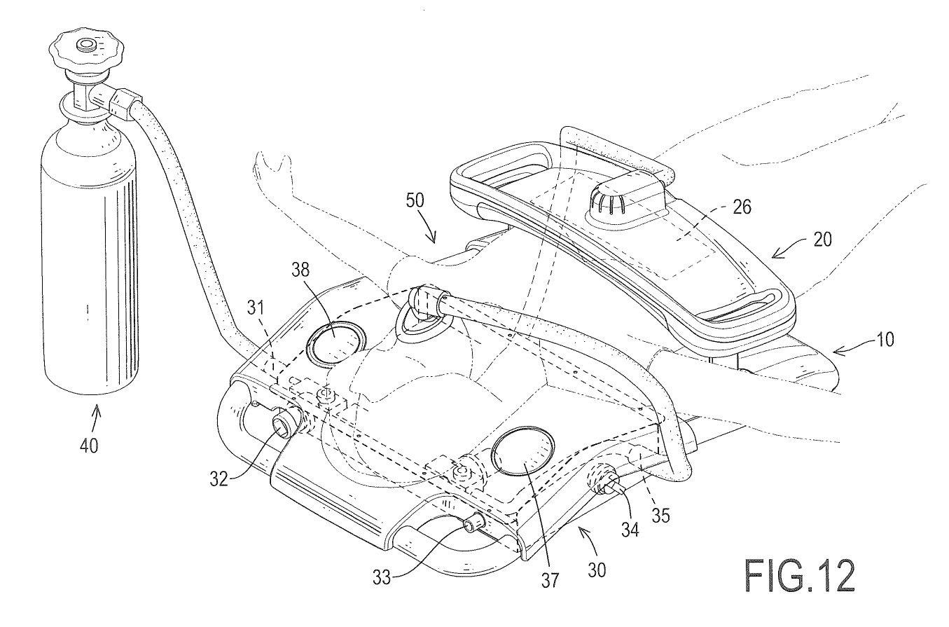

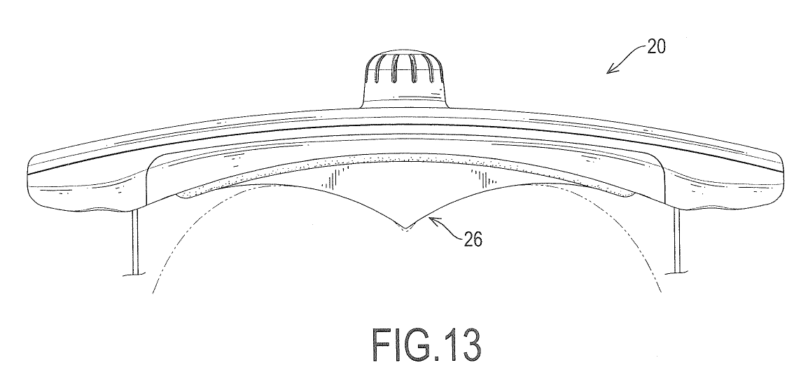

With reference to FIGS. 12 and 13, the auxiliary pad (26) is placed between the bladder (22) and a female patient's chest and has an upper surface and a lower surface. The upper surface of the auxiliary pad (26) is attached to the bladder (22). The lower surface has two recesses adjacent to each other and corresponds to a shape of the female patient's chest to facilitate compressing the female patient's chest.

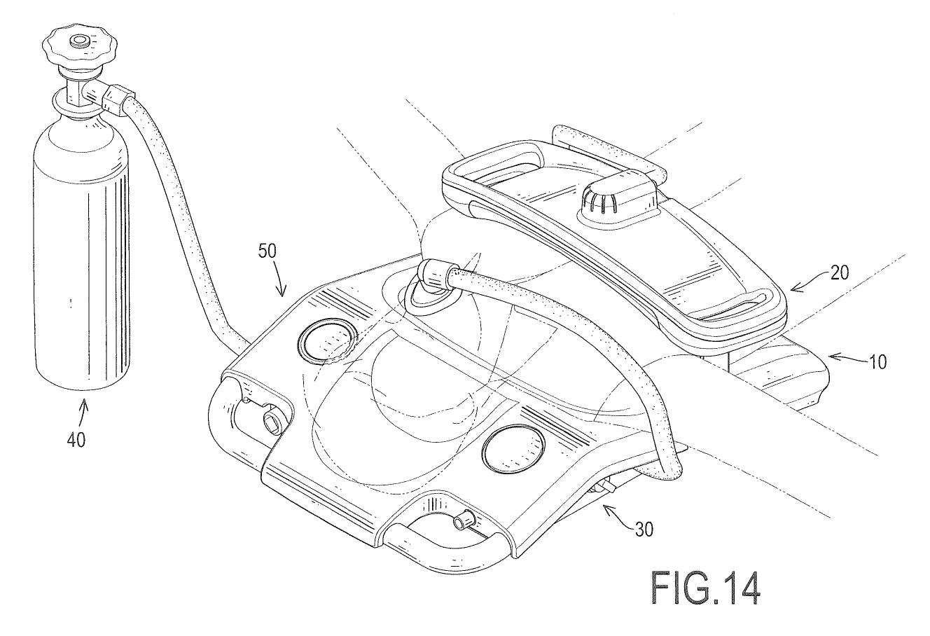

With reference to FIGS. 12 and 14, because the compressing member (20) is connected to the back plate (10) rather than wrapping directly around the patient upper body, the bladder (22) is capable of compressing the patient's chest continuously and stably when repeatedly inflating the bladder (22). Therefore, a pressure resulting from the inflation of the bladder (22) is applied only on the patient's chest rather than other parts of the patient's upper body, and this provides a good cardiac massage and CPR assist effect and prevents hurting the patient's ribs.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A pneumatic device for cardiopulmonary resuscitation assist comprising
a back plate being substantially quadrangular and having
two sides; and
two securing members being mounted respectively on the sides of the back plate; and
a compressing member being substantially quadrangular, being detachably connected to the back plate and comprising
a mounting plate having
two sides;
an upper surface;
a lower surface;
a gas passage being mounted on the upper surface of the mounting plate; and
two securing straps being respectively mounted on the sides of the mounting plate and respectively connected selectively to the securing members of the back plate; and
a bladder being mounted on the lower surface of the mounting plate and communicating with the gas passage of the mounting plate.

2. The pneumatic device for cardiopulmonary resuscitation assist as claimed in claim 1, wherein the back plate further has
a top surface having
a body securing face; and
a head placing face being connected to and being inclined relative to the body securing face; and
a receiving recess being defined in the head placing face.

3. The pneumatic device for cardiopulmonary resuscitation assist as claimed in claim 2 further comprising a control member comprising
a gas inlet being connected to the gas inlet through a gas pipe;
a gas outlet being connected to the gas pipe;
a pressure controller being connected to the gas pipe;
a flow controller being connected to the gas pipe;
a moisture gauge being connected to the gas pipe and being mounted on the head placing face; and
a pressure gauge being connected to the gas pipe and being mounted on the head placing face.

4. The pneumatic device for cardiopulmonary resuscitation assist as claimed in claim 3 further comprising
an oxygen bottle being connected to the gas inlet of the control member; and
a mask being connected to the gas outlet of the control member.

5. The pneumatic device for cardiopulmonary resuscitation assist as claimed in claim 4, wherein the control member further comprises
an inflation controller being connected to the gas pipe and communicating with the gas passage of the mounting plate through an inflation pipe to control a periodical inflation of the bladder; and
a switch being connected to the inflation controller to turn on or off the inflation of the bladder.

6. The pneumatic device for cardiopulmonary resuscitation assist as claimed in claim 5 further comprising an auxiliary pad having
an upper surface engaging the bladder; and
a lower surface having two recesses adjacent to each other.

7. The pneumatic device for cardiopulmonary resuscitation assist as claimed in claim 6, wherein
the mounting plate comprises
an upper plate;
a middle frame being mounted on the upper plate; and
a lower frame being mounted on the middle frame and having an opening; and
the bladder comprises
a lining plate being attached to the middle frame of the mounting plate and having a through hole communicating with the gas passage of the mounting plate; and
a resilient bladder sheet being attached securely to the lining plate.

8. The pneumatic device for cardiopulmonary resuscitation assist as claimed in claim 7, wherein
each securing member is a female buckle; and
each securing strap has a male buckle corresponding and connected selectively to one of the female buckles.

9. The pneumatic device for cardiopulmonary resuscitation assist as claimed in claim 8, wherein
the back plate further has two handles formed respectively on the sides of the back plate; and
the mounting plate further has two handles formed respectively on the sides of the mounting plate.

10. The pneumatic device for cardiopulmonary resuscitation assist as claimed in claim 7, wherein
each securing member comprises
a slot being defined through one of the sides of the back plate; and
a securing button being mounted beside the slot and comprising
a slide block being mounted slidably in the back plate;
a spring being mounted between the slide block and the back plate; and
a tongue being mounted on the slide block and extending selectively into the slot; and
each securing strap has a teeth portion being inserted selectively into one of the slots of the back plate, corresponding to one of the securing buttons of the back plate and having multiple teeth and one of the teeth selectively engaging the tongue of the corresponding securing button.

11. The pneumatic device for cardiopulmonary resuscitation assist as claimed in claim 1 further comprising an auxiliary pad having
an upper surface engaging the bladder; and
a lower surface having two recesses adjacent to each other.

12. The pneumatic device for cardiopulmonary resuscitation assist as claimed in claim 1, wherein
the mounting plate comprises
an upper plate;
a middle frame being mounted on the upper plate; and
a lower frame being mounted on the middle frame and having an opening; and
the bladder comprises
a lining plate being attached to the middle frame of the mounting plate and having a through hole communicating with the gas passage of the mounting plate; and
a resilient bladder sheet being attached securely to the lining plate.

13. The pneumatic device for cardiopulmonary resuscitation assist as claimed in claim 1, wherein
each securing member is a female buckle; and
each securing strap has a male buckle corresponding and connected selectively to one of the female buckles.

14. The pneumatic device for cardiopulmonary resuscitation assist as claimed in claim 1, wherein
the back plate further has two handles formed respectively on the sides of the back plate; and
the mounting plate further has two handles formed respectively on the sides of the mounting plate.

15. The pneumatic device for cardiopulmonary resuscitation assist as claimed in claim 1, wherein
each securing member comprises
a slot being defined through one of the sides of the back plate; and
a securing button being mounted beside the slot and comprising
a slide block being mounted slidably in the back plate;
a spring being mounted between the slide block and the back plate; and
a tongue being mounted on the slide block and extending selectively into the slot; and
each securing strap has a teeth portion being inserted selectively into one of the slots of the back plate, corresponding to one of the securing buttons of the back plate and having multiple teeth and one of the teeth selectively engaging the tongue of the corresponding securing button.
